(19) United States
(12) Patent Application Publication
(10) Pub. No.: US 2026/0094609 A1
(43) Pub. Date: Apr. 2, 2026

(54) METHOD FOR PROVIDING COMMUNICATION FUNCTION BASED ON CONTEXT

(71) Applicant: SPEECHWISE INC., Incheon (KR)

(72) Inventor: Bowon LEE, Incheon (KR)

(21) Appl. No.: 19/402,819

(22) Filed: Nov. 26, 2025

Related U.S. Application Data
(63) Continuation of application No. PCT/KR2024/019926, filed on Dec. 6, 2024.

(30) Foreign Application Priority Data
Oct. 2, 2024 (KR) 10-2024-0134260
Oct. 2, 2024 (KR) 10-2024-0134268

(51) Int. Cl. G10L 15/26; G06F 3/16

(52) U.S. Cl. CPC G10L 15/26; G06F 3/167

(57) ABSTRACT

A method for providing a communication function based on context according to the present invention, in the method in which a device outputs utterance information based on the context, includes acquiring pre-conversation information, displaying a plurality of cards and acquiring an interaction from a user to select at least one selection card from the plurality of cards, and outputting user utterance information associated with the at least one selection card based on context of the pre-conversation information.

### TECHNICAL FIELD

The present disclosure relates to a method and device for providing a communication function to an electronic device using a picture card or the like.

### BACKGROUND ART

With recent technological advancements, communication methods are diversifying, and in particular, there are cases in which alternative communication methods are provided for users with disabilities who have difficulty communicating verbally or non-verbally, or for users who are in environments where communication is difficult. These communication methods are sometimes referred to as augmentative and alternative communication (AAC).

There are various types of augmentative and alternative communication, and one representative type provides a plurality of picture cards having specific meanings, and when the user selects a card representing an intention the user wishes to express, utterance information corresponding to the selected card is output. This communication method using picture cards is widely used because the communication method using picture cards is easy to use and does not require expensive equipment for support.

However, such tools often do not sufficiently reflect the user's context and situation, thereby having limitations in providing accurate and context-appropriate expressions required for actual communication. Accordingly, the same word or expression may have completely different meanings in different situations, and when the meaning of the word or expression is not properly distinguished, communication errors may occur.

Therefore, demand is increasing for technology that may automatically identify the user's context, present appropriate communication cards based on the context, and generate and output utterance information appropriate for the situation.

### DISCLOSURE

### Technical Problem

An object of the present disclosure is to provide a method for outputting user utterance information associated with at least one selection card based on context of pre-conversation information in a communication function.

An object of the present disclosure is to provide a method for determining an output form in which content of user utterance information is output based on context of pre-conversation information in a communication function.

### Technical Solution

A method for providing a communication function based on context according to the present disclosure, the method in which a device outputs utterance information based on context, includes: acquiring pre-conversation information; displaying a plurality of cards and acquiring an interaction from a user to select at least one selection card from the plurality of cards, each of the plurality of cards corresponding to a respective meaning; and outputting user utterance information associated with the at least one selection card based on context of the pre-conversation information.

In one embodiment of the present disclosure, outputting the user utterance information may include: providing the pre-conversation information and information on the at least one selection card to an artificial intelligence (AI) model, and requesting, from the AI model, user utterance information associated with the at least one selection card and based on the context of the pre-conversation information; and receiving the user utterance information from the AI model and outputting the received user utterance information.

In one embodiment of the present disclosure, the method may further include acquiring information on the context based on the pre-conversation information, the acquiring being performed between acquiring the pre-conversation information and outputting the user utterance information.

In one embodiment of the present disclosure, acquiring information on the context may be performed prior to acquiring an interaction for selecting the selection card, and acquiring the interaction for selecting the selection card may include displaying a plurality of context-corresponding cards selected based on the context.

In one embodiment of the present disclosure, the method may include determining user utterance information associated with at least one selection card based on information on the context.

In one embodiment of the present disclosure, acquiring the interaction for selecting the selection card may include acquiring information on an order in which the at least one selection card is selected, and the user utterance information may be based on the information on the order.

In one embodiment of the present disclosure, acquiring the interaction for selecting the selection card may include acquiring associated gesture information related to the interaction, and the user utterance information may be based on the associated gesture information.

In one embodiment of the present disclosure, outputting the user utterance information may include:
displaying at least one utterance information candidate comprising the user utterance information; acquiring an interaction for selecting the user utterance information from the at least one utterance information candidate; and outputting user utterance information selected by the interaction for selecting the user utterance information.

In one embodiment of the present disclosure, outputting the user utterance information may include:
determining content of user utterance information associated with the at least one selection card; and determining an output form in which the determined content is output, based on the context of the pre-conversation information.

In one embodiment of the present disclosure, outputting the user utterance information may include:
determining an output form in which the determined content is output, based on the associated gesture related to the interaction.

In one embodiment of the present disclosure, when the user utterance information is output as sound, the output form may be tone information.

In one embodiment of the present disclosure, when the user utterance information is output as text, the output form may be at least one of size, color, punctuation, and emoji.

### Advantageous Effects

A method for providing a communication function based on context according to the present disclosure has the advantage of outputting user utterance information associated with at least one selection card based on context of pre-conversation information.

In addition, the method for providing a communication function based on context according to the present disclosure has the advantage of determining an output form in which content of user utterance information is output, based on the context of the pre-conversation information.

### DESCRIPTION OF DRAWINGS

FIG. 1 is a diagram illustrating an example of a network environment according to one embodiment of the present disclosure.

FIG. 2 is a flowchart illustrating an example of a process for outputting utterance information based on context according to one embodiment of the present disclosure.

FIG. 3 is a flowchart illustrating an example of a process for outputting user utterance information selected by an interaction for selecting user utterance information according to one embodiment of the present disclosure.

FIG. 4 is a flowchart illustrating an example of a process for determining an output form of user utterance information according to one embodiment of the present disclosure.

FIGS. 5 to 8 are diagrams for explaining a method of outputting utterance information based on context according to various embodiments of the present disclosure.

FIG. 9 is a flowchart illustrating an example of a process for outputting utterance information based on context according to one embodiment of the present disclosure.

### BEST MODE FOR CARRYING OUT THE INVENTION

Hereinafter, embodiments disclosed in this specification will be described in detail with reference to the accompanying drawings. Regardless of drawing numbers, identical or similar components are given the same reference numbers, and redundant descriptions of the components are omitted. In addition, when describing embodiments disclosed in this specification, a detailed description of related known technology is omitted when the detailed description is determined to obscure the gist of the embodiments disclosed in this specification.

Terms including ordinal numbers such as first and second may be used to describe various components, but the components are not limited by the terms. The terms are used solely to distinguish one component from another component.

Singular expressions include plural expressions unless the context clearly indicates otherwise.

In this application, each operation described may be performed regardless of the listed order, except in cases in which a special causal relationship requires performance in the listed order.

In this application, terms such as “include” or “have” are intended to specify the presence of a feature, number, step, operation, component, part, or combination thereof described in the specification, and the terms should be understood not to exclude in advance a possibility of the presence or addition of one or more other features, numbers, steps, operations, components, parts, or combinations thereof.

Hereinafter, the present disclosure will be described with reference to the accompanying drawings.

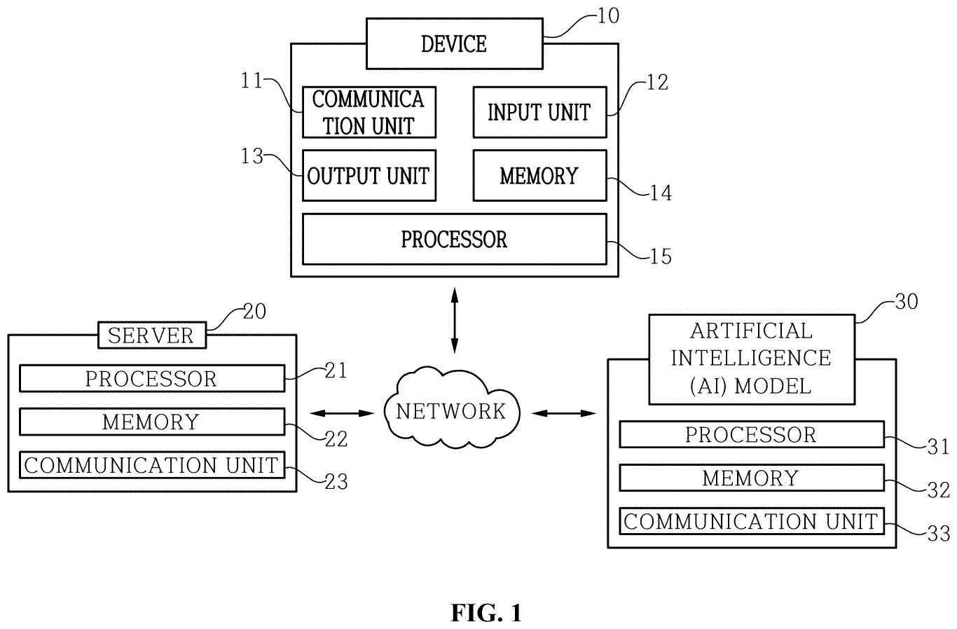

FIG. 1 is a diagram illustrating an example of a network environment according to one embodiment of the present disclosure.

A network environment according to one embodiment of the present disclosure illustrated in FIG. 1 may include a device 10 providing a communication function, a server 20, and an artificial intelligence (AI) model 30. The device 10 may include at least one electronic device 10 connected to the server 20 via a network.

The network is not limited to a communication method and may include a communication method utilizing a communication network that the network may include (e.g., a mobile communication network, a wired Internet, a wireless Internet, a broadcasting network), and may also include short-range wireless communication.

In the present disclosure, the device 10 is described as communicating with the server 20 and the AI model 30 to transmit and receive information, but in some cases, the device 10 may perform the present disclosure on the device 10 alone without communicating with the server 20 and the AI model 30. In such a case, the device 10 may not include a communication unit 11 described below.

The device 10 may be an electronic device 10 that provides a communication service. The device 10 may include a communication unit 11, an input unit 12, an output unit 13, a memory 14, and a processor 15.

The communication unit 11 may communicate with the server 20 or another device 10 or the AI model 30 in a wired/wireless manner.

The input unit 12 may receive various information through a user's operation and input actions. Such an input unit 12 may be a touch screen module, a keyboard, a mouse, a button, a camera, a stylus, or a microphone.

The device 10 may receive user interaction through the input unit 12. Interaction means that a user inputs information reflecting a user's selection or intention into the device 10 by manipulating the input unit. For example, the interaction may be touching a touch screen, clicking a mouse, typing on a keyboard, inputting sound through a microphone, capturing an image through a camera, or recognizing movement through a motion sensor.

The output unit 13 may output various information. The output unit 13 may be a display device 10, a speaker, a vibration generating device 10, a tactile generating device 10, and the like. In some cases, the output unit 13 may be a device 10 (e.g., a Bluetooth earphone) connected to the device 10 via wired communication or wireless communication (e.g., short-range wireless communication such as Bluetooth) to receive and output signals.

The memory 14 functions as a storage medium and may store a number of application programs run on the device 10, data for the operation of the device 10, and commands. Such a memory 14 may be provided in the form of various storage devices such as hardware, ROM, RAM, a flash drive, a hard drive, or in the form of web storage.

In one embodiment, the memory 14 may store an application that provides a communication service.

The processor 15 may control the overall operation of the communication unit 11, the input unit 12, the output unit 13, and the memory 14 to execute an application related to a communication service.

The device 10 may be, for example, a smartphone, a tablet computer, a laptop computer, or a dedicated terminal for providing communication functions.

In the present disclosure, the device 10 acquires pre-conversation information, acquires context information based on the pre-conversation information, displays a plurality of cards, acquires an interaction from a user to select at least one selection card from the plurality of cards, and outputs user utterance information associated with at least one selection card based on context of the pre-conversation information.

In addition, in acquiring an interaction for selecting a selection card, information on an order in which at least one selection card is selected may be acquired.

In addition, in acquiring an interaction for selecting a selection card, associated gesture information related to the interaction may be acquired.

In the present disclosure, conversation means communication conducted between a user and at least one counterpart through various means. In the present disclosure, the means of conversation are not limited. Therefore, in the present disclosure, conversation includes voice conversation through sound, text conversation through text, conversation through images or symbols reflecting emotions such as emojis or emoticons, and conversation through other auxiliary means such as sign language and the like.

In this case, the pre-conversation information refers to information on conversation conducted before displaying the plurality of cards. The pre-conversation information may be classified according to various criteria. For example, the pre-conversation information may be classified according to a conversation counterpart. In some cases, the pre-conversation information may be classified according to a situation in which conversation occurred (time, place, environment, and the like).

In this case, context of the pre-conversation information refers to information on a topic, a gist, a flow, and a key element of conversation based on the pre-conversation information. The device 10, the server 20, or the AI model 30 of the present disclosure may identify the context of the pre-conversation information based on the pre-conversation information and generate or acquire information regarding the context.

In this case, a card is a visual element used to express a specific meaning or intention and refers to an image or character object that the device 10 displays to receive an interaction regarding an expression of intention from a user. Specifically, the card may be composed of an image, a symbol, text, a shape, or a combination thereof. A plurality of cards include images, shapes or letters that correspond to the meaning. A user may select at least one card from a plurality of cards related to an intention that the user wishes to express. Hereinafter, a card selected by the user to express an intention is referred to as the selection card.

In this case, user utterance information refers to information generated in the form of a word, a sentence, or the like based on at least one selection card selected by a user to express the intension. As described above, the means of conversation in the present disclosure are not limited, so user utterance information may be output as text utterance, audio utterance, conversation through images or symbols reflecting emotions such as emojis or emoticons, or conversation through other auxiliary means such as sign language and the like.

In the present disclosure, the server 20 may be a device 10 capable of transmitting, receiving, and processing information through communication with the device 10 via a network. The server 20 may be implemented as a computer device 10 or a plurality of computer devices 10 that provide commands, codes, files, contents, or services.

The server 20 may include a processor 21, a memory 22, and a communication unit 23.

The processor 21 may provide a communication service to the device 10 by controlling operation of the memory 22 and the communication unit 23.

The memory 22 functions as a storage medium and may store a number of application programs running on the server 20, data for operation of the server 20, and commands. In one embodiment, the memory 22 may store an application that provides a communication service targeting a plurality of users.

Such a memory 22 may be provided in the form of various storage devices such as hardware, ROM, RAM, a flash drive, a hard drive, or in the form of web storage.

The communication unit 23 may communicate with the device 10 or the AI model 30 via a network in a wired or wireless manner.

The AI model 30 may include a processor 31, a memory 32, and a communication unit 33. Each detailed configuration included in the AI model 30 performs substantially the same function as each detailed configuration included in the server 20.

When the device 10 performs a communication service, the AI model 30 may receive pre-conversation information and information on at least one selection card, may operate based on context of the pre-conversation information, may receive a request for user utterance information associated with at least one selection card and based on context of the pre-conversation information, and may provide the user utterance information.

The AI model 30 is a form of artificial intelligence used to generate or predict new data through generative AI based on existing data. Specifically, the AI model may be a model that learns from input data by utilizing machine learning algorithms and deep learning networks and generates new data based on the learning.

### Mode for Carrying Out the Invention

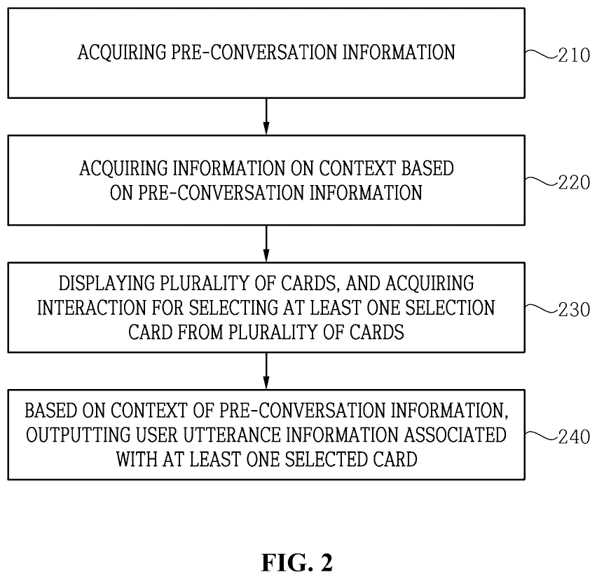

FIG. 2 is a flowchart illustrating an example of a method for providing a communication function based on context and an example of a process for outputting utterance information based on context, according to one embodiment of the present disclosure.

In operation 210, a device 10 acquires pre-conversation information.

The pre-conversation information may be information on conversation conducted before operation 110 is performed. The pre-conversation information may be conversation related to a current conversation counterpart.

To this end, the device 10 needs to acquire information on the counterpart in relation to the current conversation. Therefore, acquiring the pre-conversation information by the device 10 may include acquiring information on the counterpart and acquiring existing conversation information with the counterpart as pre-conversation information.

For example, in acquiring the information on the counterpart, the device 10 may acquire a starting utterance voice of the counterpart in the current conversation and may identify the counterpart by analyzing the voice. In addition, a user inputs information regarding an identity of the user into the device 10 when a current conversation begins, and the device 10 may identify the counterpart based on the input information.

The pre-conversation information may be classified into various types depending on various situations. Hereinafter, examples of various situations are described, and various types of pre-conversation information are described.

When a counterpart of the current conversation is specified, the device 10 may determine whether existing conversation information is present between the user and the specified counterpart prior to the current conversation and, when the existing conversation information is present, the device 10 may acquire the existing conversation information as pre-conversation information.

First, a case where existing conversation information exists between the user and the counterpart prior to performing the present disclosure is described. In this case, an existing conversation may be distinct from the current conversation that is being conducted. The existing conversation is distinct from the current conversation based on a time or situation in which an utterance occurred, and refers to a conversation conducted before the current conversation. For example, even in a conversation with the same counterpart, a conversation that started immediately before or several minutes before and continues without interruption to the present corresponds to a current conversation, and a previous conversation having an interval of several minutes to several days between the current conversation and a previous utterance corresponds to an existing conversation.

Such conversation information may include utterance information of the counterpart as well as utterance information of the user. However, in some cases, when the user or the counterpart initiates a first utterance in a conversation, only the beginning utterance (first utterance) may correspond to the current conversation.

Even when existing conversation information exists between a user and a specified counterpart, the device 10 may acquire not only the existing conversation information but also current conversation information as the pre-conversation information.

Hereinafter, a case in which no existing conversation information exists between a user and a specified counterpart is described. In such a case, only the content of current conversation may correspond to the pre-conversation information. If there is no exchange of conversation between the user and the counterpart in the current conversation, and only an initiating utterance of the user or the counterpart (the first utterance that starts the conversation) exists, information on the initiating utterance may be acquired as the pre-conversation information.

In some cases, even if existing conversation information exists between a user and a specified counterpart, context of the existing conversation with the counterpart may not be consistent, or the user may request that cards be displayed based only on context of the current conversation, rather than the existing conversation information. In such cases, the device 10 does not acquire the existing conversation information as the pre-conversation information, but may acquire only conversation immediately preceding the current conversation as the pre-conversation information.

Unlike the above-described case, there may be a case where no existing conversation exists between the user and the specified counterpart, and no initiating utterance of either the user or the specified counterpart exists in the current conversation. In such a case, conversation between the user and another counterpart, rather than the counterpart of the current conversation, may be used as the pre-conversation information.

In some cases, pre-conversation information that the device 10 may acquire may not exist. In such cases, the device 10 may generate pre-conversation information based on existing information of the user and the counterpart. For example, when no past conversation history is present between the user and the counterpart, the device 10 may generate pre-conversation information based on the user's or the counterpart's profile, preferences, response patterns in previous similar situations, and the like.

In operation 220, the device 10 acquires information on context based on the pre-conversation information.

Specifically, the device 10 may determine context of pre-conversation based on the pre-conversation information acquired in operation 210. Operation 220 may be performed using an AI model 30. The AI model may determine context information from the pre-conversation information using a large language model (LLM).

The device 10 may determine context information including a topic, a main flow, and a key element of the pre-conversation based on the pre-conversation information.

Specifically, the device 10 may automatically extract and analyze a repetitive keyword, a mentioned topic, and context information related to a major issue from the pre-conversation information. By doing so, the device 10 may determine main content and direction of the conversation.

For example, when the user frequently mentions investments and pre-conversation on a specific market takes place, the device 10 may acquire context information on the name of the specific market, reflecting the user's interest, along with keywords such as “stock,” “market,” and “investment risk” in an investment-related conversation. In addition, the device 10 may analyze context in which the keywords are used to more accurately determine meanings of the keywords. For example, the term “market” may mean a financial market, a commodity market, or a general market environment, and the device 10 may determine meaning of “market” in an investment conversation by analyzing a relationship of the term to other elements of the conversation.

In operation 230, the device 10 displays a plurality of cards and acquires an interaction from the user to select at least one selection card from the plurality of cards.

The device 10 displays the plurality of cards, which are visual elements used to express a specific meaning or intention, and the user may select, from the plurality of cards, at least one card related to the intention to be expressed by the user. Hereinafter, a card selected by the user to express an intention is referred to as a selection card. In this case, the plurality of cards may be displayed with priority given to topics and response options highly relevant to context of pre-conversation information. For example, when the user has recently mentioned a travel plan, the device 10 may present a plurality of cards including destination recommendation, budget planning, safety tip, and the like.

The device 10 may display the plurality of cards by classifying the plurality of cards into at least one high-level concept (category) and sub-concepts (specific items), thereby allowing the user to clearly express an intention. For example, assume that a plurality of cards based on context of “a question about summer vacation plans” are determined as mountain, sea, house, hotel, domestic, overseas, train, airplane, bus, car, subway, hiking, swimming, beach, barbecue, reading, rest, same day, 1 night 2 days, 2 nights 3 days, 3 nights 4 days, 1 week, 1 month, family, friend, lover, alone, parents, and pet. In such a case, cards such as mountain, sea, house, hotel, domestic, and overseas may be displayed as sub-concepts of the location card. Also, cards such as train, airplane, bus, car, subway, and the like may be displayed as sub-concepts of the transportation card, cards such as hiking, swimming, beach, barbecue, reading, rest, and the like may be displayed as sub-concepts of the activity card, cards such as same day, 1 night 2 days, 2 nights 3 days, 3 nights 4 days, 1 week, and 1 month may be displayed as sub-concepts of the period card, and family, friend, lover, alone, parents, and pet may be displayed as sub-concepts of the companion card.

The device 10 displays cards corresponding to the high-level concepts in a separate area, and when any one of the cards corresponding to the high-level concepts is selected, a card corresponding to a sub-concept of the selected high-level concept may be displayed in a related area. In the example described above, cards corresponding to the high-level concepts of location, transportation, activity, period, and companion are displayed in a separate area, and when the user selects a location card, cards such as mountain, sea, house, hotel, domestic, and overseas may be displayed in a related area.

The device 10 may, while performing operation 230, acquire information on an order in which at least one selection card is selected.

Specifically, the device 10 may identify the user's decision-making pattern and preference by recording and analyzing the order of each card selected by the user. For example, when the user selects the ‘Overseas Travel’ and ‘Domestic Destination’ cards before selecting the ‘Car’ card, the device 10 may identify the ‘Car’ card as a means of transportation, for example, a rental or travel vehicle. On the other hand, when the user selects the ‘Car Dealership’ and ‘New Car Review’ cards before selecting the ‘Car’ card, the device 10 may determine the selection of the ‘Car Dealership’ and ‘New Car Review’ cards as an interest in purchasing a car.

The device 10 may, while performing operation 230, acquire associated gesture information related to an interaction.

Specifically, the device 10 may acquire associated gesture information including a touch pattern, a swipe movement, or any other gesture that is made when the user selects a card on a touchscreen interface. For example, a user's long-press or double-tap on a card may indicate a deeper interest in the card or a request for additional information.

In operation 240, the device 10 outputs user utterance information associated with at least one selection card, based on the context of the pre-conversation information.

There may be a plurality of user utterance information that may correspond to at least one selection card. Based on the context of the pre-conversation information, the device 10 or server 20 may determine user utterance information based on a selection card that is most suitable for the conversation context.

For example, suppose that the user has selected three cards: “Jeju Island,” “Friends,” and “Hiking.” The utterance information corresponding to the three selection cards may be “I will go to Jeju Island with a friend and go hiking” or “My friend went to Jeju Island to go hiking.” In this case, if the context information of the pre-conversation information is “a question about summer vacation plans,” the device 10 or server 20 may determine “I will go to Jeju Island with a friend and go hiking” as the user utterance information based on the context of the pre-conversation information.

The user utterance information may be displayed by the same means as the pre-conversation. For example, when the pre-conversation is a voice conversation, the user utterance information may also be output as a voice conversation, and when the pre-conversation is a text message, the user utterance information may also be output as a text message.

In some cases, the user utterance information may be supplemented with auxiliary means of expression that reflect context information from pre-conversation information. The auxiliary means of expression may include tone of voice, volume, emojis or emoticons, and font of text. For example, if the user's utterance information is determined to be appropriate for “anticipatory excitement” based on the context of the pre-conversation information, the user's utterance information may be output as a voice conversation with a tone corresponding to “anticipatory excitement.”

Operation 240 may also be performed using the AI model 30. Specifically, the device 10 may provide pre-conversation information and information on at least one selection card to the AI model 30, may request user utterance information associated with at least one selection card based on the context of the pre-conversation information, may receive the user utterance information from the AI model 30, and may output the received the user utterance information.

In addition, based on information on the context, the device 10 may determine user utterance information from at least one user utterance information received from the AI model 30. For example, suppose that the user has selected three cards: ‘Museum’, ‘Historical Site’, and ‘Art Gallery’. In response to the selection of the three cards, when the AI model 30 generates various user utterance information such as “Do you want to see a special exhibition at a museum?”, “Do you want to take a guided tour of a historical site?”, or “Do you want to see the latest artwork at an art gallery?”, the device 10 may analyze previous choices and interests of the user to determine “Do you want to take a guided tour of a historical site?” as user utterance information.

The device 10 may output user utterance information associated with at least one selection card, based on the order information.

Specifically, the device 10 may determine importance of each card and intention of the user by analyzing the order of cards selected by the user, and may generate utterance information by giving priority to elements regarded as important by the user.

For example, when a user selects, from three cards of ‘Food’, ‘Party Location’, and ‘Music’, the cards of ‘Food’, ‘Music’, and ‘Party Location’ in the order as mentioned, the device 10 may interpret that the user considers food and music to be important elements in relation to a party, and may generate an expression of intention asking for detailed information or preferences regarding the corresponding elements.

Alternatively, when the user selects the cards in the order of ‘Party Location’, ‘Food’, and ‘Music’, the device 10 may generate an expression of intention regarding how to adjust other elements based on a location selected first, or regarding how to select the other elements in consideration of characteristics of the location selected first.

The device 10 may output user utterance information associated with at least one selection card based on the associated gesture information.

Specifically, the device 10 may determine the user's intention by analyzing gesture information such as strength, length, and pattern of a touch that is made when the user selects a card on the touchscreen. For example, the user's gesture of long-pressing or tapping multiple times on a card may indicate a strong interest in the card or a request for additional information.

For example, when the user selects three cards ‘Watching Movies’, ‘Listening to Music’, and ‘Reading Books’, and performs a strong gesture, such as long-pressing or tapping multiple times, especially on the card ‘Watching Movies’, user utterance information such as “I like music and books, but I prefer watching movies the most” may be generated.

In some cases, the device 10 may display a card corresponding to a sub-concept of the selection card, based on associated gesture information for the selection card.

Specifically, by analyzing associated gesture information for a selection card, the device 10 may provide additional cards of a subcategory of a highlighted selection card, thereby reflecting the user's expression of intention in more detail.

For example, when the user selects the card ‘Travel Plan’ and highlights the card ‘Beach Trip’ with a gesture, such as pulling down the card ‘Beach Trip’, the device 10 may display additional option cards related to Beach Trip. For example, cards such as ‘Swimsuit Selection’, ‘Beach Activities’, and ‘Beach Nearby Accommodation Recommendations’ may be displayed.

Alternatively, the gesture information may also be used to determine the user's urgency. For example, when the user quickly and strongly taps the card ‘First Aid’ multiple times, the device 10 may recognize an emergency situation of the user and may immediately display a response such as, “Would you like to see first aid instructions immediately, or would you like to be directed to the nearest medical facility?”

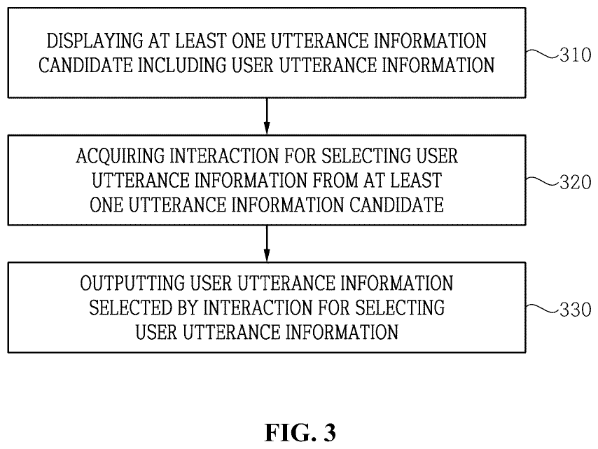

FIG. 3 is a flowchart illustrating an example of a process for outputting user utterance information selected by an interaction for selecting user utterance information according to one embodiment of the present disclosure.

In operation 310, a device 10 displays at least one utterance information candidate including user utterance information.

Specifically, the device 10 may provide a variety of utterance options related to a selection card selected by the user, allowing the user to select the utterance most appropriate for the situation.

For example, when the user selects a card related to “Travel Plan,” the device 10 may display utterance information candidates such as “What activities would you like to do on this trip?”, “Is there a special place you would like to visit during your trip?”, or “Would you like to discuss your travel itinerary?”

In some cases, the device 10 may further customize utterance information candidates based on previous interactions from the user or provided context. For example, when the user has frequently mentioned a particular type of travel, the device may display more specialized options such as “How about a beach vacation?” or “I would like this trip to include mountains.”

In operation 320, the device 10 acquires an interaction for selecting user utterance information from at least one utterance information candidate.

For example, when the user uses a touchscreen, the user may tap the text “What activities would you like to do on this trip?” to select the text from the utterance candidates for “Travel Plan.” Alternatively, when voice recognition is used, the user may make a selection using a voice command such as “Please select the first option.”

In some cases, the device 10 may recommend and display the most frequently used utterance information or the utterance information most recently selected to simplify the user's selection process.

In operation 330, the device 10 outputs user utterance information selected by an interaction for selecting user utterance information.

Specifically, the device 10 may display the user-selected utterance information on the screen or read it out loud through voice output so that the user may use it as a means of communication. This allows the user to continue the conversation based on content selected by the user.

For example, if the user selects “What activities would you like to do on this trip?” from the utterances for ‘Travel Plan’, the device 10 may display the sentence in large letters on the screen or output the sentence clearly through a speaker.

In some cases, the device 10 may suggest an additional interaction based on the user's selection. For example, when the user asks a question and waits for an answer, the device 10 may suggest the user's next utterance or the conversational partner's next utterance to keep the conversation flowing.

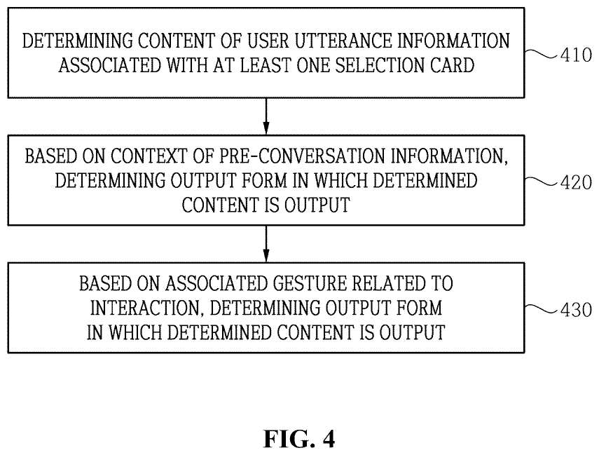

FIG. 4 is a flowchart illustrating an example of a process for determining an output form of user utterance information according to one embodiment of the present disclosure.

In operation 410, a device 10 determines content of user utterance information associated with at least one selection card.

Specifically, by analyzing a relationship between the at least one selection card selected by the user and a subject of each of the at least one selection card, the device 10 may generate utterance content appropriate for a situation

For example, when the user selects three cards ‘Vacation Plan,’ ‘Beach,’ and ‘Reading Books,’ the device may construct user utterance information by considering how the cards may be connected. In this case, user utterance information such as “Would you like to relax and read a book on the beach during your vacation?” or “What do you think about spending a relaxing vacation on the beach while reading a favorite book?” may be suggested.

In operation 420, the device 10 determines an output form in which the determined content is output, based on context of pre-conversation information.

Specifically, by analyzing contextual factors such as the user's preferences, emotional state, and urgency of conversation based on context of the pre-conversation information, the device 10 may determine an output form in which user utterance information may be most appropriately conveyed.

For example, in a situation where the user feels tense in a previous conversation, a voice output may be used to convey user utterance information in a soothing tone of voice that may be calming. Alternatively, in a situation where conveying information is important, details may be clearly presented in a text form to allow the user to easily check the information.

In some cases, when the user is active or distracted, the device 10 may emphasize key points of a message by utilizing a visual element. For example, when the user's attention is dispersed, important information may be displayed in a large text or graphics so that the user may recognize the information quickly.

In operation 430, the device 10 determines an output form in which the determined content is output based on an associated gesture related to an interaction.

Specifically, by analyzing the type and strength of a gesture by which the user selects a card, the device 10 may provide user utterance information in various forms such as text, audio, emoji, or emoticon.

For example, when the user uses a long-press gesture on a screen, the device 10 may interpret the gesture as a signal requesting more detailed information and provide the information in a large text message or in an audio form.

In some cases, when the user uses a gesture such as tapping a screen, an emoticon reflecting the user's mood may be added to utterance content by the device 10 to induce a more friendly and emotional response.

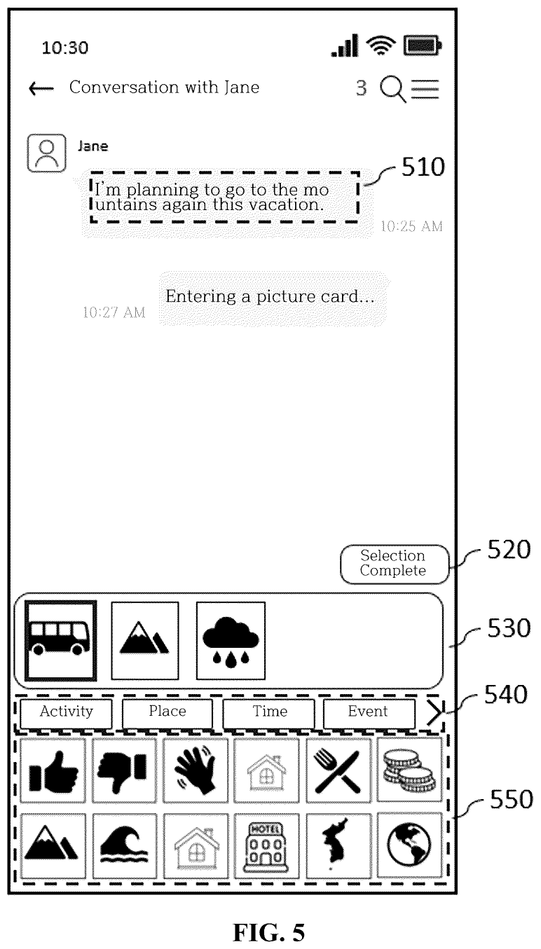

FIGS. 5 to 8 are diagrams for explaining a method of outputting utterance information based on context according to various embodiments of the present disclosure.

Referring to FIG. 5, a plurality of cards corresponding to respective meanings may be displayed in a card area 550. A user may select one or more cards from the card area 550, and the selected cards are presented in a selection card area 530. Referring to FIG. 5, the cards ‘Transportation’, ‘Mountain’, and ‘Weather’ are displayed in the selection card area 530.

In addition, a keyword category 540 indicating an upper classification of cards is displayed. When the user selects a specific word in the keyword category 540, cards of a sub-classification corresponding to the specific word are displayed in the card area 550.

When the user completes selecting a card to express an intention, a selection completion interface 520 may request generation of user utterance information corresponding to the selected card.

For example, based on the user's selection cards of ‘Transportation’, ‘Mountain’, and ‘Weather’, user utterance information such as “What type of transportation do you plan to use to get to that mountain?, where is that mountain located?, Have you checked the weather on that day?” may be generated.

In some cases, the device 10 may further customize the utterance information candidates based on previous interactions from the user or provided context. Specifically, when the user has frequently mentioned a particular type of travel, the device 10 may suggest a specific travel destination recommendation or planning question to the user, in consideration of the particular type of travel. For example, the device 10 may generate customized utterance information such as, “Are you thinking of revisiting a mountain with a trail you liked last time, or would you like to explore a new trail?”

In addition, the device 10 may provide advice for weather changes based on the selected card ‘Weather’, such as, “It is recommended to prepare a waterproof jacket or umbrella in case of unexpected weather changes.”

The device 10 may output user utterance information based on information on an order in which the selection cards are selected. For example, when the user selects the cards ‘Transportation’, ‘Mountain’, and ‘Weather’ in this order, this order may reflect the focus of the trip the user is planning. User utterance information such as, “You are planning a trip to the mountains. What type of transportation do you plan to use? Have you checked the weather on your expected travel date?” may be generated.

Alternatively, when the user selects the cards in the order of ‘Weather’, ‘Mountain’, and ‘Transportation’, the device 10 may adjust user utterance information by giving priority to the weather conditions. For example, user utterance information such as, “The weather may not be good on the date you selected. If you are planning a hike, it is important to be aware of weather changes and choose the appropriate means of transportation,” may be provided.

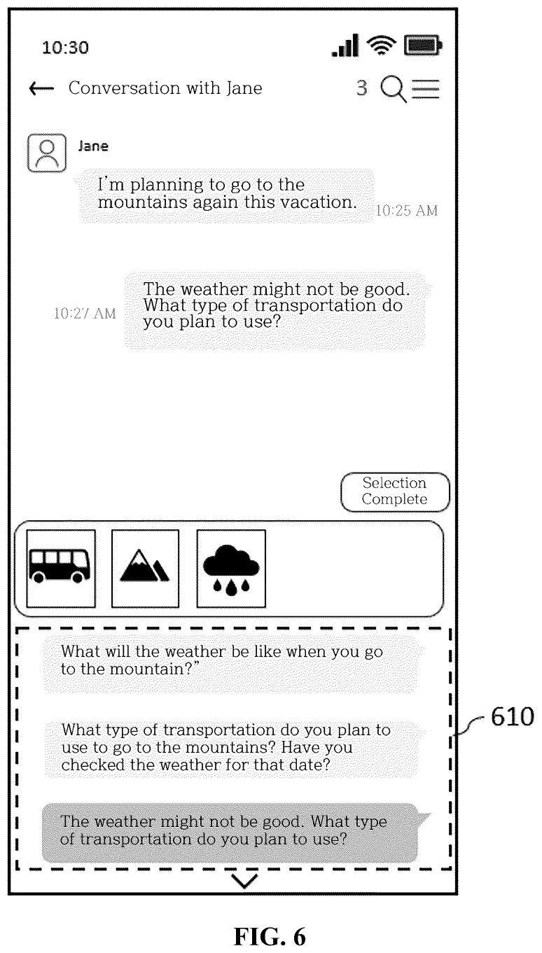

Referring to FIG. 6, a plurality of user utterance information candidates displayed on the device 10 are indicated as utterance information candidates 610. The utterance information candidates 610 include options such as “What will the weather be like when you go to the mountain?”, “What type of transportation do you plan to use to go to the mountains? Have you checked the weather for that date?”, and “The weather might not be good. What type of transportation do you plan to use?”. In this case, when the utterance information selected by the user is “The weather might not be good. What type of transportation do you plan to use?”, the device 10 may output the user-selected utterance information.

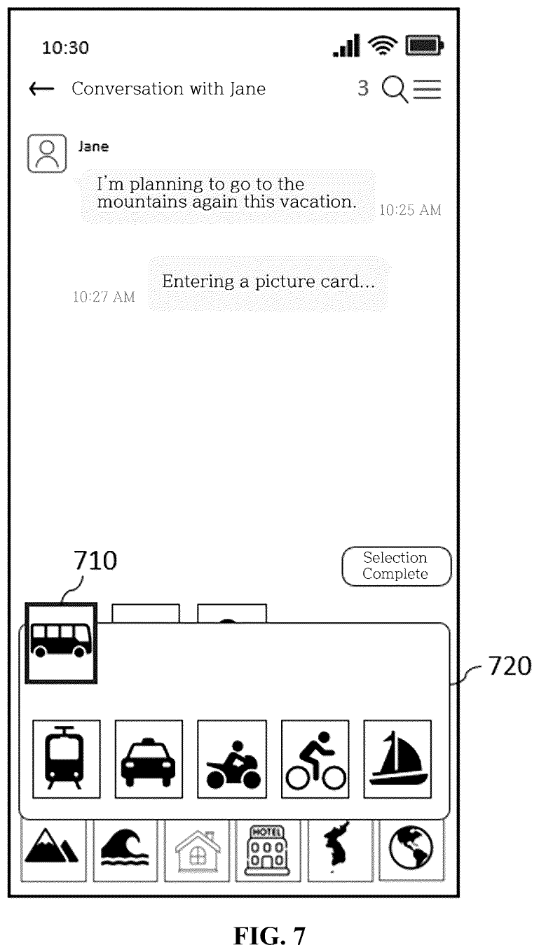

Referring to FIG. 7, the device 10 detects associated gesture information indicating the user's long-press on the transportation card 710 within the selection card area 530, and displays a transportation specific card area 720 corresponding to a sub-concept of the transportation card 710. In this area, the user may view various transportation options and select a specific card, such as train, taxi, boat, motorbike, bicycle, or the like.

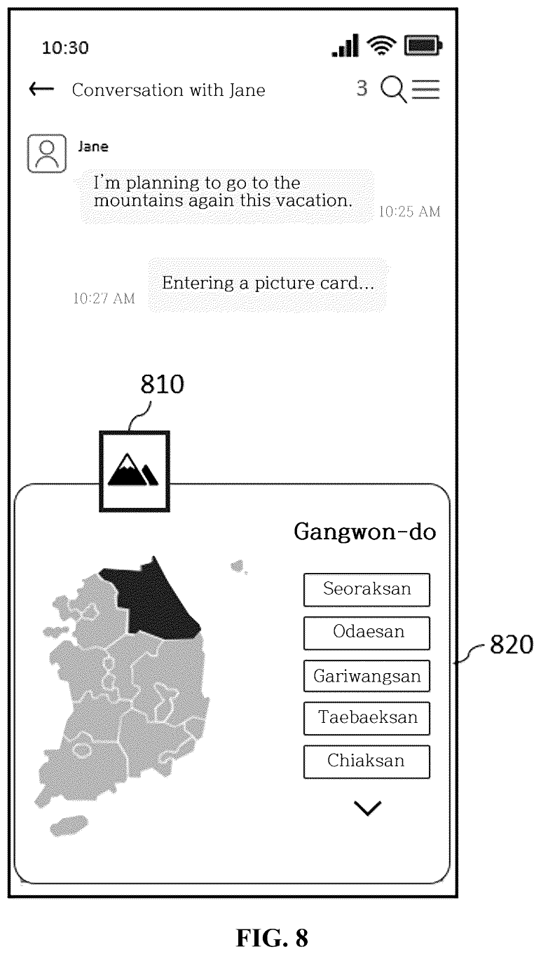

Referring to FIG. 8, a case in which the user acquires associated gesture information for a mountain card 810 within the selection card area 530 is displayed. For example, when the user performs a downward gesture while pressing the mountain card 810, the device 10 displays a specific map interface 820. This interface displays a specific map of the region selected by the user, and may display mountains corresponding to the “Gangwon-do region” selected by the user on the map.

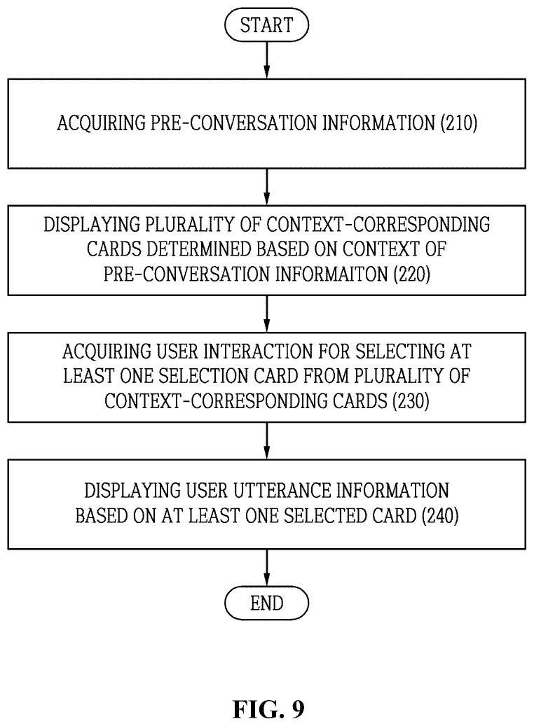

As illustrated in FIG. 9, the device 10 of the present disclosure may acquire pre-conversation information, display a plurality of context-corresponding cards determined based on context of the pre-conversation information, acquire a user interaction for selecting at least one selection card from the plurality of context-corresponding cards, and output user utterance information based on the at least one selection card.

In this case, the context of the pre-conversation information refers to information on a topic, a gist, a flow, and a thread of conversation based on pre-conversation information. In the present disclosure, a card refers to an image or character object that the device 10 displays to receive an interaction regarding an expression of intention from the user. In this case, a context-corresponding card refers to a card selected or determined based on the context of the pre-conversation information. A context-corresponding card may be a card that is relevant to the context of the pre-conversation information, or a card that the user may likely select based on the pre-conversation information. In this case, user utterance information refers to information expressing an intention, generated in a form of a word, a sentence, or the like based on at least one selection card selected by the user. As described above, the means of conversation in the present disclosure are not limited, so user utterance information may be output as voice utterance, text utterance, conversation through images or symbols reflecting emotions such as emojis or emoticons, and conversation through other auxiliary means such as sign language.

In operation 210, the device 10 acquires pre-conversation information. The pre-conversation information may be conversation information conducted before operation 210 is performed. The pre-conversation information may be conversation related to a current conversation counterpart.

In operation 220, the device 10 displays a plurality of context-corresponding cards determined based on context of the pre-conversation information.

In operation 230, the device 10 acquires a user interaction for selecting at least one selection card from the plurality of context-corresponding cards.

In operation 240, the device 10 outputs user utterance information based on at least one selection card.

The technical features disclosed in each embodiment of the present disclosure are not limited to that embodiment, and, unless they are mutually incompatible, the technical features disclosed in each embodiment may be combined and applied to different embodiments.

Therefore, although each embodiment focuses on its own technical features, each technical feature may be applied in combination with each other as long as they are not mutually incompatible.

The present disclosure is not limited to the above-described embodiments and the accompanying drawings, and various modifications and variations are possible from the viewpoint of a person skilled in the art to which the present disclosure pertains. Therefore, the scope of the present disclosure should be defined not only by the claims of this specification but also by equivalents thereof.

1. A method for a device to provide a communication function based on context, comprising:
acquiring pre-conversation information;
displaying a plurality of cards and acquiring an interaction from a user to select at least one selection card from the plurality of cards, each of the plurality of cards corresponding to a respective meaning; and
outputting user utterance information associated with the at least one selection card based on context of the pre-conversation information.

2. The method of claim 1, wherein outputting the user utterance information comprises:
providing the pre-conversation information and information on the at least one selection card to an artificial intelligence (AI) model, and requesting, from the AI model, user utterance information associated with the at least one selection card and based on the context of the pre-conversation information; and
receiving the user utterance information from the AI model and outputting the received user utterance information.

3. The method of claim 1, further comprising acquiring information on the context based on the pre-conversation information, the acquiring being performed between acquiring the pre-conversation information and outputting the user utterance information.

4. The method of claim 3,
wherein acquiring information on the context is performed prior to acquiring an interaction for selecting the selection card, and
wherein acquiring the interaction for selecting the selection card comprises displaying a plurality of context-corresponding cards selected based on the context.

5. The method of claim 3, further comprising determining user utterance information associated with at least one selection card based on information on the context.

6. The method of claim 1,
wherein acquiring the interaction for selecting the selection card comprises acquiring information on an order in which the at least one selection card is selected, and
wherein the user utterance information is based on the information on the order.

7. The method of claim 1,
wherein acquiring the interaction for selecting the selection card comprises acquiring associated gesture information related to the interaction, and
wherein the user utterance information is based on the associated gesture information.

8. The method of claim 1, wherein outputting the user utterance information comprises:
displaying at least one utterance information candidate comprising the user utterance information;
acquiring an interaction for selecting the user utterance information from the at least one utterance information candidate; and
outputting user utterance information selected by the interaction for selecting the user utterance information.

9. The method of claim 1, wherein outputting the user utterance information comprises:
determining content of user utterance information associated with the at least one selection card; and
determining an output form in which the determined content is output, based on the context of the pre-conversation information.

10. The method of claim 9, wherein outputting the user utterance information comprises determining an output form in which the determined content is output, based on the associated gesture related to the interaction.

11. The method of claim 9, wherein when the user utterance information is output as sound, the output form is tone information.

12. The method of claim 9, wherein when the user utterance information is output as text, the output form is at least one of size, color, punctuation, and emoji.
